(19) United States
(12) Patent Application Publication
(10) Pub. No.: US 2017/0212865 A1
(43) Pub. Date: Jul. 27, 2017

(54) METHODS AND APPARATUS FOR IMPROVING BUFFER SIZE SETTING FOR ONE OR MORE BUFFER STATUS REPORTS

(71) Applicant: QUALCOMM Incorporated, San Diego, CA (US)

(72) Inventors: Yue YANG, San Diego, CA (US); Aziz GHOLMIEH, Del Mar, CA (US); Gang Andy XIAO, San Diego, CA (US); Peng WU, Shanghai (CN); Saket BATHWAL, Hyderabad (IN); Bao Vinh NGUYEN, San Diego, CA (US); Srinivasan BALASUBRAMANIAN, San Diego, CA (US); Shailesh MAHESHWARI, San Diego, CA (US)

(21) Appl. No.: 15/006,299

(22) Filed: Jan. 26, 2016

(51) Int. Cl. G06F 15/167; H04L 12/26

(52) U.S. Cl. CPC G06F 15/167; H04L 43/0876

(57) ABSTRACT

Certain aspects of the present disclosure relate to methods and apparatus for improving buffer size setting for one or more buffer status reports, such as one or more extended buffer status reports (eBSRs) in a wireless communication system. According to certain aspects, a method is provided herein for wireless communications performed by a user equipment (UE). The method generally includes determining a first amount of data stored in a buffer at the UE; and if the first amount of the data satisfies (e.g., is equal to or greater than) a threshold, sending a first BSR indicating a second amount of buffered data at the UE greater than the first amount. As a result, the UE may be scheduled by the base station for a greater amount uplink resources for transmitting the buffered data.

### BACKGROUND

Field of the Disclosure

The present disclosure relates generally to wireless communication and, more particularly, to methods and apparatus for improving buffer size setting for one or more buffer status reports (e.g., one or more extended buffer status reports (eBSRs)).

Description of Related Art

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE/LTE-Advanced is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “DETAILED DESCRIPTION” one will understand how the features of this disclosure provide advantages that include improved communications between access points and stations in a wireless network.

The present disclosure relates generally to wireless communication, and more particularly, to methods and apparatus for improving buffer size setting for one or more buffer status reports (e.g., one or more extended buffer status reports (eBSRs)).

Certain aspects of the present disclosure provide a method for wireless communications by a user equipment (UE). The method generally includes determining a first amount of data stored in a buffer at the UE and if the first amount of the data satisfies (e.g., is equal to or greater than) a threshold, sending a first BSR indicating a second amount of buffered data at the UE greater than the first amount.

Certain aspects of the present disclosure provide an apparatus for wireless communications by a UE. The apparatus generally includes means for determining a first amount of data stored in a buffer at the UE and means for sending a first BSR indicating a second amount of buffered data at the UE greater than the first amount if the first amount of the data satisfies a threshold.

Certain aspects of the present disclosure provide an apparatus for wireless communications by a UE. The apparatus generally includes at least one processor configured to determine a first amount of data stored in a buffer at the UE and configured to send a first BSR indicating a second amount of buffered data at the UE greater than the first amount if the first amount of the data satisfies a threshold; and a memory coupled with the at least one processor.

Certain aspects of the present disclosure provide a computer readable medium having computer executable code stored thereon. The computer executable code generally includes code for determining a first amount of data stored in a buffer at the UE and code for sending a first BSR indicating a second amount of buffered data at the UE greater than the first amount if the first amount of the data satisfies a threshold.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. The appended drawings illustrate only certain typical aspects of this disclosure, however, and are therefore not to be considered limiting of its scope, for the description may admit to other equally effective aspects.

FIG. 1 is a diagram illustrating an example of a network architecture.

FIG. 2 is a diagram illustrating an example of an access network.

FIG. 3 is a diagram illustrating an example of a DL frame structure in LTE.

FIG. 4 is a diagram illustrating an example of an UL frame structure in LTE.

FIG. 5 is a diagram illustrating an example of a radio protocol architecture for the user and control plane.

FIG. 6 is a diagram illustrating an example of an evolved Node B and user equipment in an access network, in accordance with certain aspects of the disclosure.

FIG. 7 illustrates an example buffer size table for one or more buffer status reports, for example, an extended buffer status report (eBSR), in accordance with certain aspects of the present disclosure.

FIG. 8 is a flow diagram illustrating example operations, performed by a user equipment (UE), for setting buffer size for an eBSR, in accordance with certain aspects of the present disclosure.

FIG. 9 is an example flow diagram illustrating cross layer querying for BSR, in accordance with aspects of the present disclosure.

FIG. 10 is an example flow diagram illustrating a one-shot increase of buffer size setting for eBSR, in accordance with aspects of the present disclosure.

FIG. 11 is a graph illustrating the one-shot increase of buffer size setting for eBSR, in accordance with certain aspects of the present disclosure.

FIG. 12 is an example flow diagram illustrating a gradual increase of buffer size setting for eBSR, in accordance with aspects of the present disclosure.

FIG. 13 is a graph illustrating the gradual increase of buffer size setting for eBSR, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Buffer status reporting procedures are used by user equipment (UE) to provide the serving eNodeB (eNB) with information about the amount of data available for transmission in buffers associated with the UE for uplink transmission. The eNB can use the information in the BSR to schedule uplink transmission resources for the UE. Extended buffer status reporting procedures may allow for large amounts of data to be reported in the eBSR; however, the maximum UE buffer size may be smaller the maximum amounts that can be reported in the eBSR. Thus, the UE does not make use of the full range of the eBSR. As a result, the UE may be allocated fewer and/or smaller uplink transmission grants by the eNB. In addition, buffer size reporting procedures do not account for buffered data in high layers.

Aspects of the present disclosure discuss techniques for improving buffer size setting for one or more BSR by reporting “fake” buffer size setting values that are larger than actual than the actual amount of data in the UE buffer, in order to increase the UE's chances of receiving more and/or larger uplink grants from the eNB.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspect. Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using hardware, software, or combinations thereof. Whether such elements are implemented as hardware or software depends upon the particular application and design constraints imposed on the overall system.

An access point (“AP”) may comprise, be implemented as, or known as NodeB, Radio Network Controller (“RNC”), eNodeB (eNB), Base Station Controller (“BSC”), Base Transceiver Station (“BTS”), Base Station (“BS”), Transceiver Function (“TF”), Radio Router, Radio Transceiver, Basic Service Set (“BSS”), Extended Service Set (“ESS”), Radio Base Station (“RBS”), or some other terminology.

An access terminal (“AT”) may comprise, be implemented as, or be known as an access terminal, a subscriber station, a subscriber unit, a mobile station, a remote station, a remote terminal, a user terminal, a user agent, a user device, user equipment (UE), a user station, a wireless node, or some other terminology. In some implementations, an access terminal may comprise a cellular telephone, a smart phone, a cordless telephone, a Session Initiation Protocol (“SIP”) phone, a wireless local loop (“WLL”) station, a personal digital assistant (“PDA”), a tablet, a netbook, a smartbook, an ultrabook, a handheld device having wireless connection capability, a Station (“STA”), or some other suitable processing device connected to a wireless modem. Accordingly, one or more aspects taught herein may be incorporated into a phone (e.g., a cellular phone, a smart phone), a computer (e.g., a desktop), a portable communication device, a portable computing device (e.g., a laptop, a personal data assistant, a tablet, a netbook, a smartbook, an ultrabook), wearable device (e.g., smart watch, smart glasses, smart bracelet, smart wristband, smart ring, smart clothing, etc.), medical devices or equipment, biometric sensors/devices, an entertainment device (e.g., music device, video device, satellite radio, gaming device, etc.), a vehicular component or sensor, smart meters/sensors, industrial manufacturing equipment, a global positioning system device, or any other suitable device that is configured to communicate via a wireless or wired medium. In some aspects, the node is a wireless node. A wireless node may provide, for example, connectivity for or to a network (e.g., a wide area network such as the Internet or a cellular network) via a wired or wireless communication link. Some UEs may be considered machine-type communication (MTC) UEs, which may include remote devices that may communicate with a base station, another remote device, or some other entity. Machine type communications (MTC) may refer to communication involving at least one remote device on at least one end of the communication and may include forms of data communication which involve one or more entities that do not necessarily need human interaction. MTC UEs may include UEs that are capable of MTC communications with MTC servers and/or other MTC devices through Public Land Mobile Networks (PLMN), for example. Examples of MTC devices include sensors, meters, location tags, monitors, drones, robots/robotic devices, etc. MTC UEs, as well as other types of UEs, may be implemented as NB-IoT (e.g., narrowband internet of things) devices.

It is noted that while aspects may be described herein using terminology commonly associated with 3G and/or 4G wireless technologies, aspects of the present disclosure can be applied in other generation-based communication systems, such as 5G and later.

### An Example Wireless Communication System

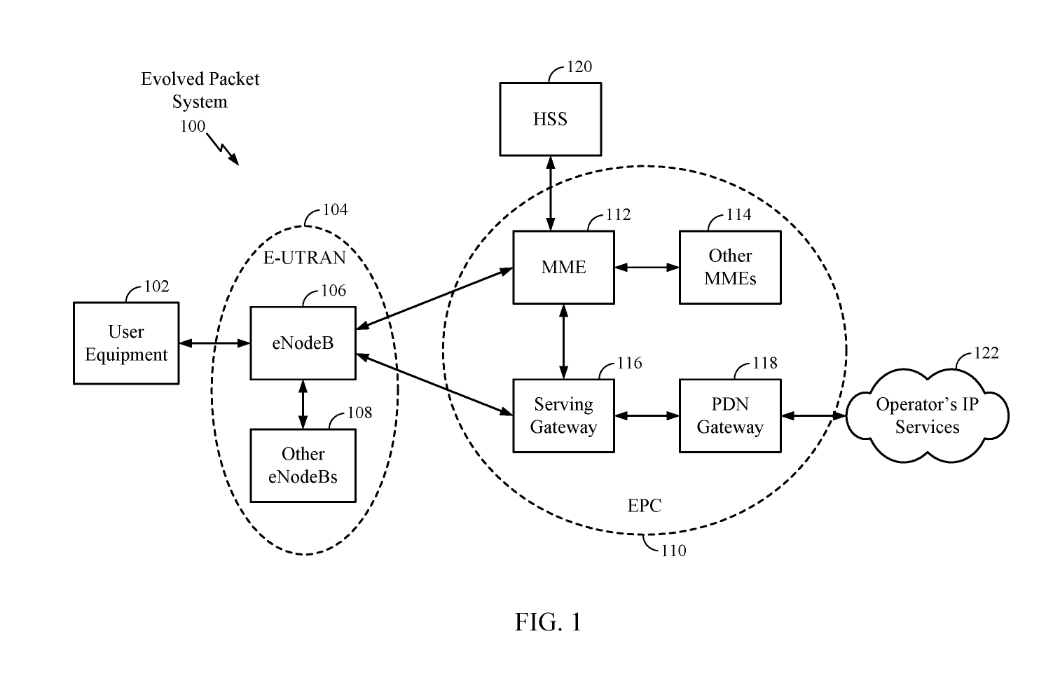

FIG. 1 is a diagram illustrating an LTE network architecture 100 in which aspects of the present disclosure may be practiced. For example, the UE 102 can determine a first amount of data buffered at the UE 102. If the determined first amount of data at the UE buffer is equal to or greater than a threshold, the UE 102 can send a buffer status report (e.g., an extended BSR) indicating a second amount of data buffered at the UE greater than the first amount (e.g., a “fake” buffer size setting).

The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. Exemplary other access networks may include an IP Multimedia Subsystem (IMS) PDN, Internet PDN, Administrative PDN (e.g., Provisioning PDN), carrier-specific PDN, operator-specific PDN, and/or GPS PDN. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 106 and other eNBs 108. The eNB 106 provides user and control plane protocol terminations toward the UE 102. The eNB 106 may be connected to the other eNBs 108 via an X2 interface (e.g., backhaul). The eNB 106 may also be referred to as a base station, a base transceiver station, a radio base station, a radio transceiver, a transceiver function, a basic service set (BSS), an extended service set (ESS), an access point, or some other suitable terminology. The eNB 106 may provide an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a netbook, a smart book, an ultrabook, a drone, a robot, a sensor, a monitor, a meter, or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include, for example, the Internet, the Intranet, an IP Multimedia Subsystem (IMS), and a PS (packet-switched) Streaming Service (PSS). In this manner, the UE102 may be coupled to the PDN through the LTE network.

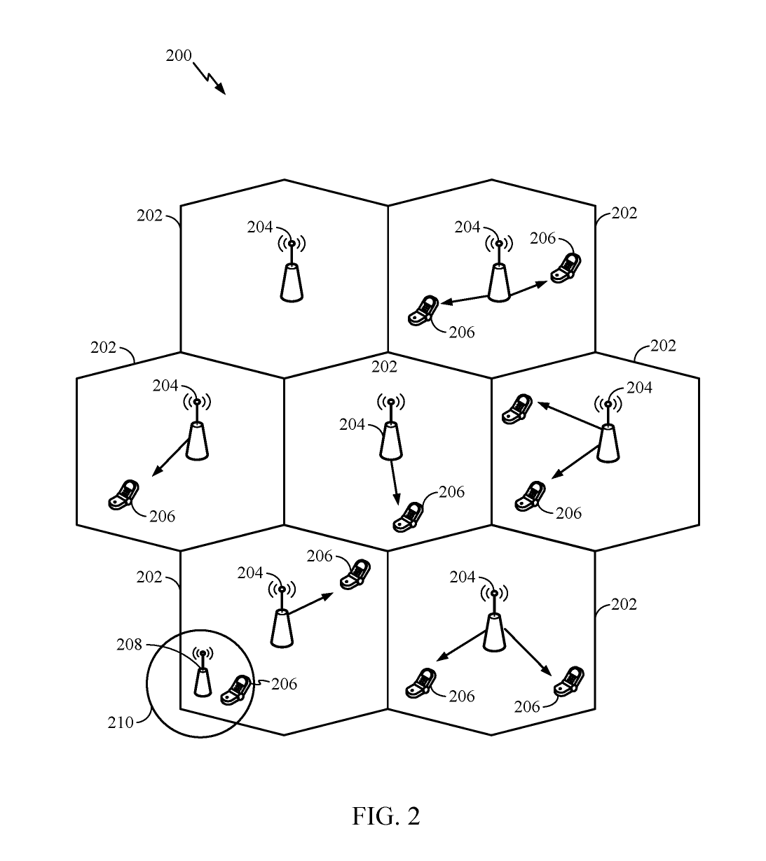

FIG. 2 is a diagram illustrating an example of an access network 200 in an LTE network architecture in which aspects of the present disclosure may be practiced. For example, UEs 206 may be configured to implement techniques for improving buffer size setting for a BSR, such as an eBSR, described in aspects of the present disclosure.

In this example, the access network 200 is divided into a number of cellular regions (cells) 202. One or more lower power class eNBs 208 may have cellular regions 210 that overlap with one or more of the cells 202. A lower power class eNB 208 may be referred to as a remote radio head (RRH). The lower power class eNB 208 may be a femto cell (e.g., home eNB (HeNB)), pico cell, or micro cell. The macro eNBs 204 are each assigned to a respective cell 202 and are configured to provide an access point to the EPC 110 for all the UEs 206 in the cells 202. There is no centralized controller in this example of an access network 200, but a centralized controller may be used in alternative configurations. The eNBs 204 are responsible for all radio related functions including radio bearer control, admission control, mobility control, scheduling, security, and connectivity to the serving gateway 116. The network 200 may also include one or more relays (not shown). According to one application, a UE may serve as a relay.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204 may have multiple antennas supporting MIMO technology. The use of MIMO technology enables the eNBs 204 to exploit the spatial domain to support spatial multiplexing, beamforming, and transmit diversity. Spatial multiplexing may be used to transmit different streams of data simultaneously on the same frequency. The data streams may be transmitted to a single UE 206 to increase the data rate or to multiple UEs 206 to increase the overall system capacity. This is achieved by spatially precoding each data stream (e.g., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

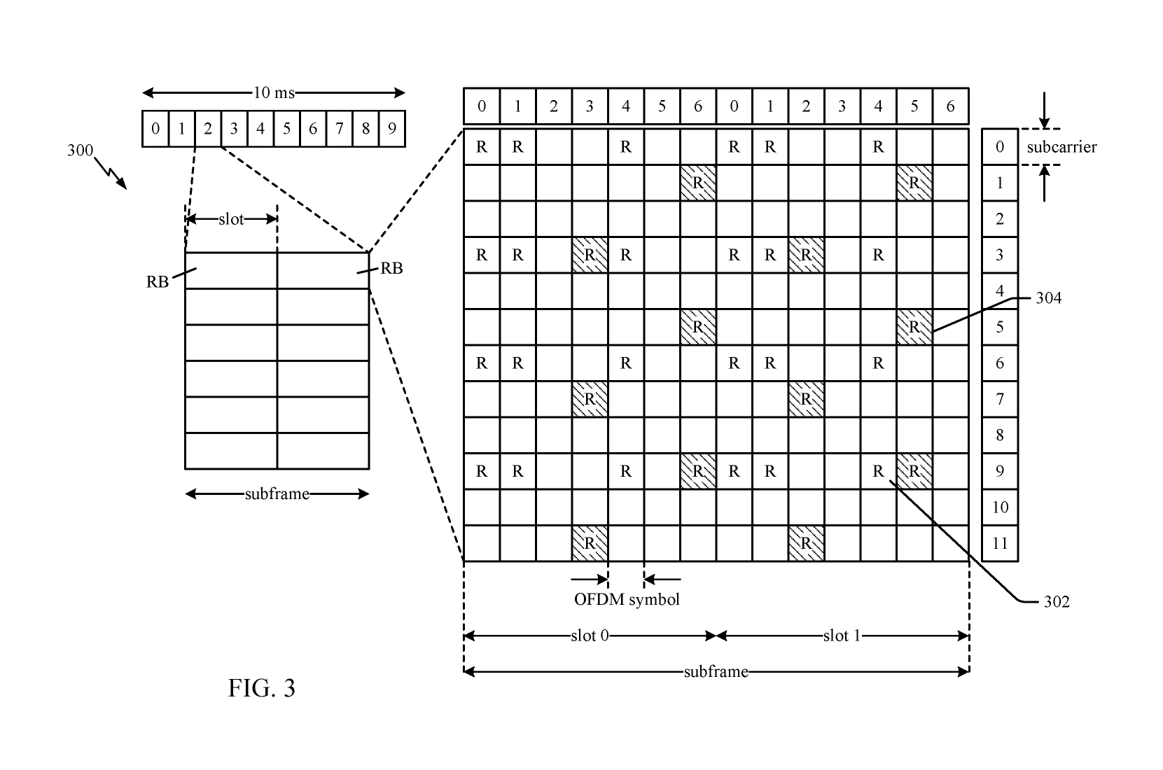

FIG. 3 is a diagram 300 illustrating an example of a DL frame structure in LTE. A frame (10 ms) may be divided into 10 equally sized sub-frames with indices of 0 through 9. Each sub-frame may include two consecutive time slots. A resource grid may be used to represent two time slots, each time slot including a resource block. The resource grid is divided into multiple resource elements. In LTE, a resource block includes 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 302, R 304, include DL reference signals (DL-RS). The DL-RS include Cell-specific RS (CRS) (also sometimes called common RS) 302 and UE-specific RS (UE-RS) 304. UE-RS 304 are transmitted only on the resource blocks upon which the corresponding physical DL shared channel (PDSCH) is mapped. The number of bits carried by each resource element depends on the modulation scheme. Thus, the more resource blocks that a UE receives and the higher the modulation scheme, the higher the data rate for the UE.

In LTE, an eNB may send a primary synchronization signal (PSS) and a secondary synchronization signal (SSS) for each cell in the eNB. The primary and secondary synchronization signals may be sent in symbol periods 6 and 5, respectively, in each of subframes 0 and 5 of each radio frame with the normal cyclic prefix (CP). The synchronization signals may be used by UEs for cell detection and acquisition. The eNB may send a Physical Broadcast Channel (PBCH) in symbol periods 0 to 3 in slot 1 of subframe 0. The PBCH may carry certain system information.

The eNB may send a Physical Control Format Indicator Channel (PCFICH) in the first symbol period of each subframe. The PCFICH may convey the number of symbol periods (M) used for control channels, where M may be equal to 1, 2 or 3 and may change from subframe to subframe. M may also be equal to 4 for a small system bandwidth, e.g., with less than 10 resource blocks. The eNB may send a Physical HARQ Indicator Channel (PHICH) and a Physical Downlink Control Channel (PDCCH) in the first M symbol periods of each subframe. The PHICH may carry information to support hybrid automatic repeat request (HARQ). The PDCCH may carry information on resource allocation for UEs and control information for downlink channels. The eNB may send a Physical Downlink Shared Channel (PDSCH) in the remaining symbol periods of each subframe. The PDSCH may carry data for UEs scheduled for data transmission on the downlink.

The eNB may send the PSS, SSS, and PBCH in the center 1.08 MHz of the system bandwidth used by the eNB. The eNB may send the PCFICH and PHICH across the entire system bandwidth in each symbol period in which these channels are sent. The eNB may send the PDCCH to groups of UEs in certain portions of the system bandwidth. The eNB may send the PDSCH to specific UEs in specific portions of the system bandwidth. The eNB may send the PSS, SSS, PBCH, PCFICH, and PHICH in a broadcast manner to all UEs, may send the PDCCH in a unicast manner to specific UEs, and may also send the PDSCH in a unicast manner to specific UEs.

A number of resource elements may be available in each symbol period. Each resource element (RE) may cover one subcarrier in one symbol period and may be used to send one modulation symbol, which may be a real or complex value. Resource elements not used for a reference signal in each symbol period may be arranged into resource element groups (REGs). Each REG may include four resource elements in one symbol period. The PCFICH may occupy four REGs, which may be spaced approximately equally across frequency, in symbol period 0. The PHICH may occupy three REGs, which may be spread across frequency, in one or more configurable symbol periods. For example, the three REGs for the PHICH may all belong in symbol period 0 or may be spread in symbol periods 0, 1, and 2. The PDCCH may occupy 9, 18, 36, or 72 REGs, which may be selected from the available REGs, in the first M symbol periods, for example. Only certain combinations of REGs may be allowed for the PDCCH. In aspects of the present methods and apparatus, a subframe may include more than one PDCCH.

A UE may know the specific REGs used for the PHICH and the PCFICH. The UE may search different combinations of REGs for the PDCCH. The number of combinations to search is typically less than the number of allowed combinations for the PDCCH. An eNB may send the PDCCH to the UE in any of the combinations that the UE will search.

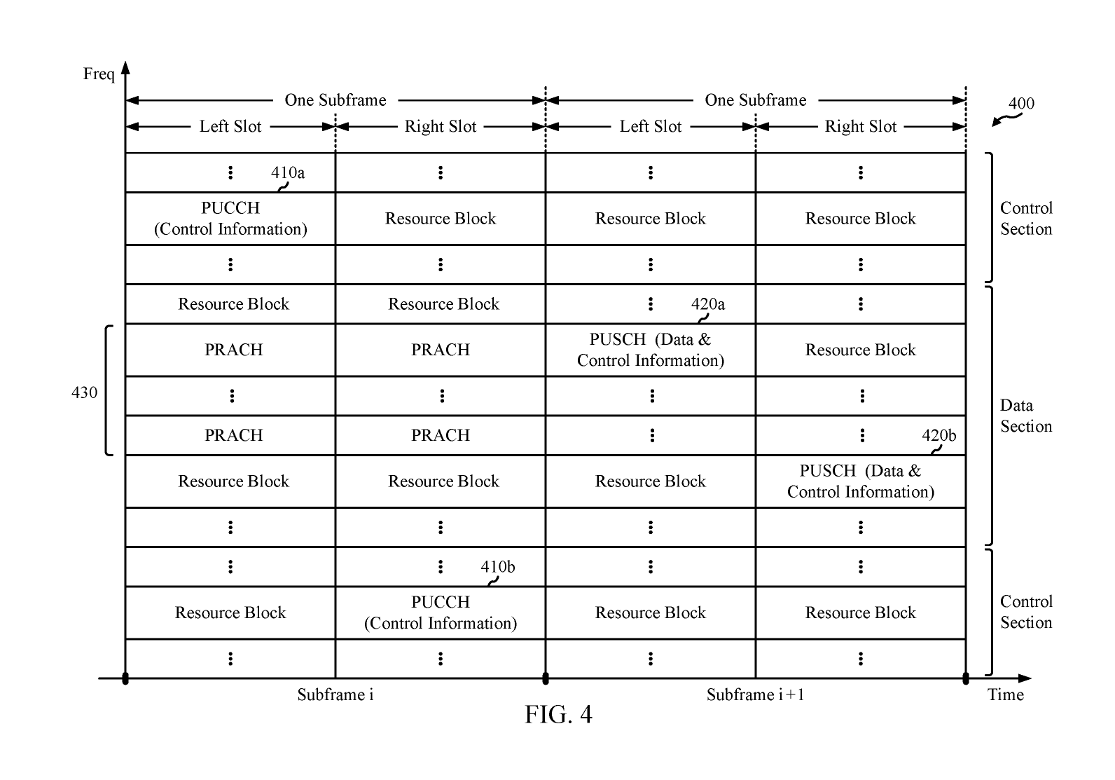

FIG. 4 is a diagram 400 illustrating an example of an UL frame structure in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The UL frame structure results in the data section including contiguous subcarriers, which may allow a single UE to be assigned all of the contiguous subcarriers in the data section.

A UE may be assigned resource blocks 410a, 410b in the control section to transmit control information to an eNB. The UE may also be assigned resource blocks 420a, 420b in the data section to transmit data to the eNB. The UE may transmit control information in a physical UL control channel (PUCCH) on the assigned resource blocks in the control section. The UE may transmit only data or both data and control information in a physical UL shared channel (PUSCH) on the assigned resource blocks in the data section. A UL transmission may span both slots of a subframe and may hop across frequency.

A set of resource blocks may be used to perform initial system access and achieve UL synchronization in a physical random access channel (PRACH) 430. The PRACH 430 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

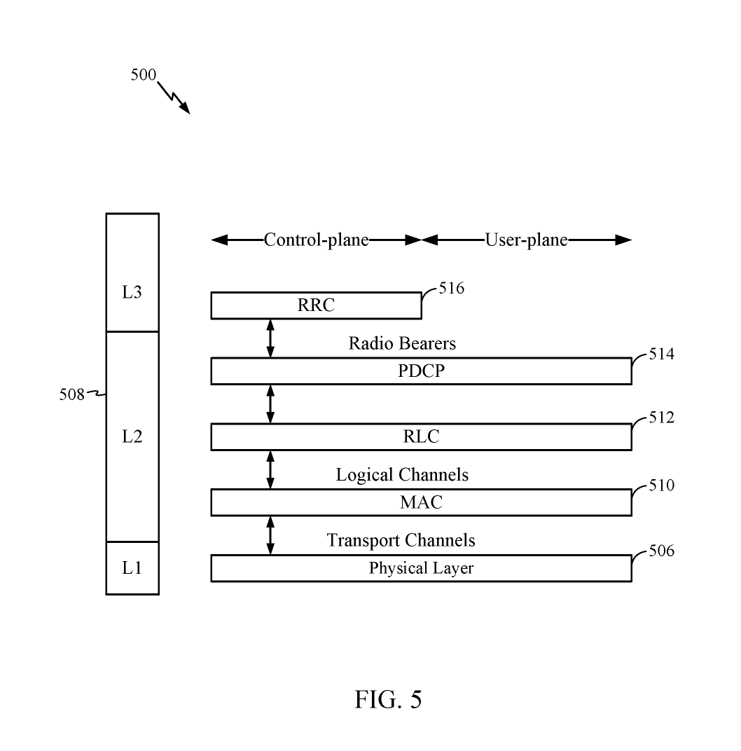

FIG. 5 is a diagram 500 illustrating an example of a radio protocol architecture for the user and control planes in LTE. The radio protocol architecture for the UE and the eNB is shown with three layers: Layer 1, Layer 2, and Layer 3. Layer 1 (L1 layer) is the lowest layer and implements various physical layer signal processing functions. The L1 layer will be referred to herein as the physical layer 506. Layer 2 (L2 layer) 508 is above the physical layer 506 and is responsible for the link between the UE and eNB over the physical layer 506.

In the user plane, the L2 layer 508 includes a media access control (MAC) sublayer 510, a radio link control (RLC) sublayer 512, and a packet data convergence protocol (PDCP) 514 sublayer, which are terminated at the eNB on the network side. Although not shown, the UE may have several upper layers above the L2 layer 508 including a network layer (e.g., IP layer) that is terminated at the PDN gateway 118 on the network side, and an application layer that is terminated at the other end of the connection (e.g., far end UE, server, etc.).

The PDCP sublayer 514 provides multiplexing between different radio bearers and logical channels. The PDCP sublayer 514 also provides header compression for upper layer data packets to reduce radio transmission overhead, security by ciphering the data packets, and handover support for UEs between eNBs. The RLC sublayer 512 provides segmentation and reassembly of upper layer data packets, retransmission of lost data packets, and reordering of data packets to compensate for out-of-order reception due to hybrid automatic repeat request (HARQ). The MAC sublayer 510 provides multiplexing between logical and transport channels. The MAC sublayer 510 is also responsible for allocating the various radio resources (e.g., resource blocks) in one cell among the UEs. The MAC sublayer 510 is also responsible for HARQ operations.

In the control plane, the radio protocol architecture for the UE and eNB is substantially the same for the physical layer 506 and the L2 layer 508 with the exception that there is no header compression function for the control plane. The control plane also includes a radio resource control (RRC) sublayer 516 in Layer 3 (L3 layer). The RRC sublayer 516 is responsible for obtaining radio resources (i.e., radio bearers) and for configuring the lower layers using RRC signaling between the eNB and the UE.

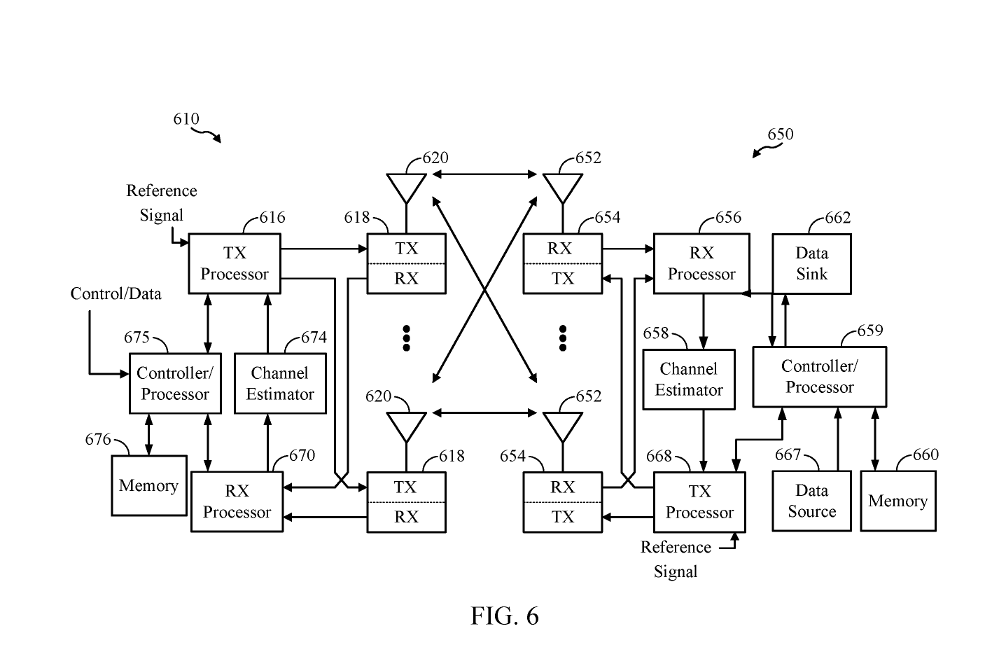

FIG. 6 is a block diagram of an eNB 610 in communication with a UE 650 in an access network, in which aspects of the present disclosure may be practiced.

In the DL, upper layer packets from the core network are provided to a controller/processor 675. The controller/processor 675 implements the functionality of the L2 layer. In the DL, the controller/processor 675 provides header compression, ciphering, packet segmentation and reordering, multiplexing between logical and transport channels, and radio resource allocations to the UE 650 based on various priority metrics. The controller/processor 675 is also responsible for HARQ operations, retransmission of lost packets, and signaling to the UE 650.

The TX processor 616 implements various signal processing functions for the L1 layer (i.e., physical layer). The signal processing functions includes coding and interleaving to facilitate forward error correction (FEC) at the UE 650 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 674 may be used to determine the coding and modulation scheme, as well as for spatial processing. The channel estimate may be derived from a reference signal and/or channel condition feedback transmitted by the UE 650. Each spatial stream is then provided to a different antenna 620 via a separate transmitter 618TX. Each transmitter 618TX modulates an RF carrier with a respective spatial stream for transmission.

At the UE 650, each receiver 654RX receives a signal through its respective antenna 652. Each receiver 654RX recovers information modulated onto an RF carrier and provides the information to the receiver (RX) processor 656. The RX processor 656 implements various signal processing functions of the L1 layer. The RX processor 656 performs spatial processing on the information to recover any spatial streams destined for the UE 650. If multiple spatial streams are destined for the UE 650, they may be combined by the RX processor 656 into a single OFDM symbol stream. The RX processor 656 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 610. These soft decisions may be based on channel estimates computed by the channel estimator 658. The soft decisions are then decoded and deinterleaved to recover the data and control signals that were originally transmitted by the eNB 610 on the physical channel. The data and control signals are then provided to the controller/processor 659.

The controller/processor 659 implements the L2 layer. The controller/processor can be associated with a memory 660 that stores program codes and data. The memory 660 may be referred to as a computer-readable medium. In the UL, the controller/processor 659 provides demultiplexing between transport and logical channels, packet reassembly, deciphering, header decompression, control signal processing to recover upper layer packets from the core network. The upper layer packets are then provided to a data sink 662, which represents all the protocol layers above the L2 layer. Various control signals may also be provided to the data sink 662 for L3 processing. The controller/processor 659 is also responsible for error detection using an acknowledgement (ACK) and/or negative acknowledgement (NACK) protocol to support HARQ operations.

In the UL, a data source 667 is used to provide upper layer packets to the controller/processor 659. The data source 667 represents all protocol layers above the L2 layer. Similar to the functionality described in connection with the DL transmission by the eNB 610, the controller/processor 659 implements the L2 layer for the user plane and the control plane by providing header compression, ciphering, packet segmentation and reordering, and multiplexing between logical and transport channels based on radio resource allocations by the eNB 610. The controller/processor 659 is also responsible for HARQ operations, retransmission of lost packets, and signaling to the eNB 610.

Channel estimates derived by a channel estimator 658 from a reference signal or feedback transmitted by the eNB 610 may be used by the TX processor 668 to select the appropriate coding and modulation schemes, and to facilitate spatial processing. The spatial streams generated by the TX processor 668 are provided to different antenna 652 via separate transmitters 654TX. Each transmitter 654TX modulates an RF carrier with a respective spatial stream for transmission.

The UL transmission is processed at the eNB 610 in a manner similar to that described in connection with the receiver function at the UE 650. Each receiver 618RX receives a signal through its respective antenna 620. Each receiver 618RX recovers information modulated onto an RF carrier and provides the information to a RX processor 670. The RX processor 670 may implement the L1 layer.

The controller/processor 675 implements the L2 layer. The controller/processor 675 can be associated with a memory 676 that stores program codes and data. The memory 676 may be referred to as a computer-readable medium. In the UL, the controller/processor 675 provides demultiplexing between transport and logical channels, packet reassembly, deciphering, header decompression, control signal processing to recover upper layer packets from the UE 650. Upper layer packets from the controller/processor 675 may be provided to the core network. The controller/processor 675 is also responsible for error detection using an ACK and/or NACK protocol to support HARQ operations. The controllers/processors 675, 659 may direct the operations at the eNB 610 and the UE 650, respectively.

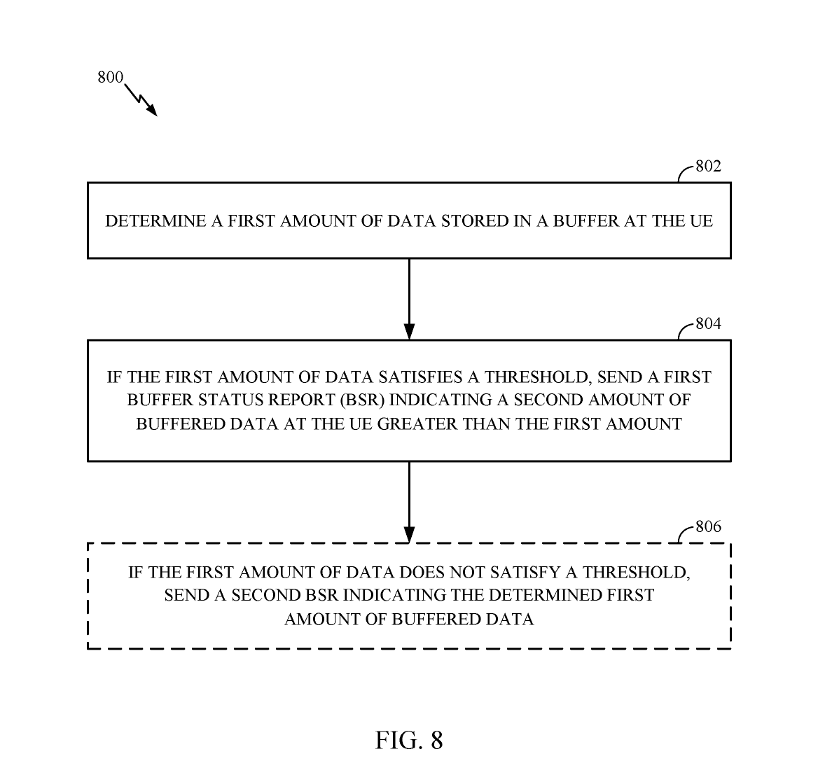

The controller/processor 659 and/or other processors, components and/or modules at the UE 650 may perform or direct operations, for example, operations 800 in FIG. 8, and/or other processes for the techniques described herein for improving buffer size setting for one or more BSRs. In certain aspects, one or more of any of the components shown in FIG. 6 may be employed to perform example operations 800 and/or other processes for the techniques described herein. The memories 660 and 676 may store data and program codes for the UE 650 and eNB 610 respectively, accessible and executable by one or more other components of the UE 650 and the eNB 610.

### Example Techniques for Improving Buffer Size Setting for a Buffer Status Report

Buffer status reporting procedures are used to provide the serving eNodeB (eNB) with information about the amount of data available for transmission in the uplink buffers associated with the medium access control (MAC) entity. For example, the BSR is a MAC layer message (e.g., control element) sent from the user equipment (UE) to the network (e.g., eNB) and carries information on how much data is in the UE buffer to be sent out. The BSR may act as a type of request for the eNB to provide an uplink grant to the UE to send the buffered data.

The eNB can use the BSR from the UE to schedule the UE for uplink transmission resources (e.g., send an uplink grant or resource allocation) according to the reported buffer status.

Two types of BSRs are Short/Truncated BSR and Long BSR. Both types of BSR include one or more Buffer Size fields that identifies the total amount of data available across all logical channels of a corresponding logical channel group after all MAC protocol data units (PDUs) for the transmission time interval (TTI) have been built. The amount of data in the buffer is indicated in number of bytes. The length of the Buffer Size field is 6 bits, for example. The bits can be mapped to a buffer size table. Values of the bits can correspond to indices (e.g., 0-63) for entries in the table. In aspects, one or more such entries can be associated with a buffer size value or with a range of buffer size values.

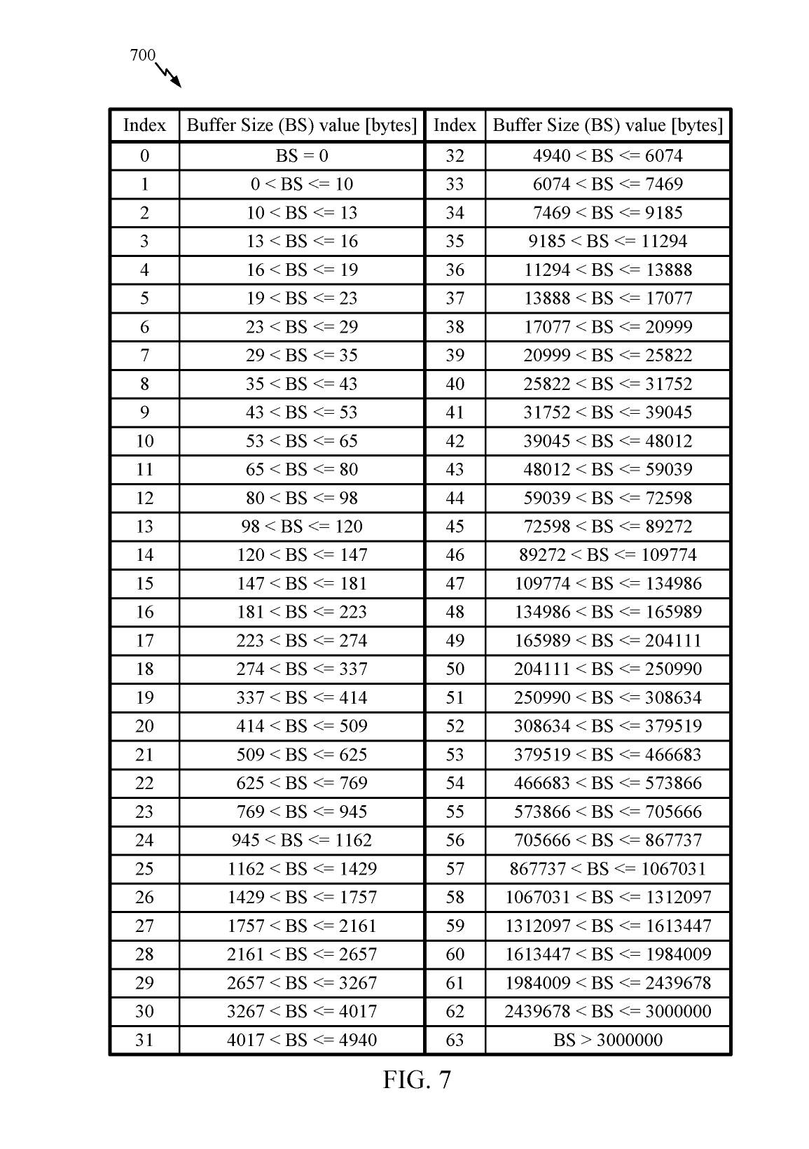

If extended buffer status reporting (e.g., extendedBSR-Sizes) procedure is configured, values up to greater than 3 MB can be indicated by the eBSR. Table 700 illustrated in FIG. 7 shows indices and corresponding buffer (e.g., the Layer 2 buffer) size values for extended buffer status reporting.

Although extended buffer status reporting may allow up a greater than 3 MB of Layer 2 buffered data to be indicated, the actual Layer 2 buffer size in the UE may be below 3 MB. In this case, there is no chance for the UE to report such a high buffer status in the BSR or make full use of the Buffer Size field range of an eBSR. As a result, the UE is likely to be allocated fewer and/or smaller uplink transmission grants by the eNB.

In aspects, as the amount of data in the Layer 2 buffer approaches the buffer size limitation (e.g., 2 MB, although other buffer size limitations may occur), it is likely that there are some data remained queued in the buffer of upper layer, which is not delivered to the Layer 2 buffer because of the buffer size limitation of the Layer 2. Under this scenario, it is preferable for a UE to get even more uplink transmission grants, so that the UE is able to transmit the queued data from both the Layer 2 buffer and the upper layer more efficiently (e.g., as soon as possible).

Accordingly, techniques for buffer size setting for extended BSR are desirable.

Aspects of the present disclose provide techniques for improving buffer size setting for one or more BSRs, such as eBSRs, by reporting “fake”, spoofed, or artificial buffer size setting values that are larger than an actual amount of data in the UE buffer, in order to increase the UE's chances of receiving more and/or larger uplink grants from the eNB.

FIG. 8 illustrates example operations 800 for setting one or more buffer sizes for an extended BSR, in accordance with certain aspects of the present disclosure. The operations 800 may be performed, for example, by a UE (e.g., UE 102). The operations 800 begin, at 802, by determining a first amount of data stored in a buffer (e.g., a current layer's buffer) at the UE.

At 804, the UE sends a first buffer status report (e.g., an eBSR) indicating a second amount of buffered data (e.g., a second amount of buffered date in the current layer's buffer) at the UE greater than the first amount if the first amount of the data satisfies (e.g., is equal to or greater than) a threshold (e.g., a percentage of the current layer's buffer size, such as 80% of the current layer's buffer size), such as a first threshold. In one example aspect, the indicated second amount of buffered data is greater than a maximum size of the buffer (e.g., the current layer's buffer). For example, the second amount may correspond to the maximum entry from the table 700. In another example aspect, the second amount may be less than the maximum entry from the table 700 and the UE may increase the amount indicated in subsequent BSRs up to the maximum entry as long as the amount of buffered data at the UE satisfies (e.g., is equal to or greater than) the threshold. In yet another aspect, the UE receives information from a higher layer regarding an amount of buffered data at the higher layer. In this example, the second amount may be based on (e.g., equal to the sum of) the first amount and the second amount. In an aspect, the current layer may be an L2 layer and the higher layer may be an L3 layer, for example. In an aspect, the current layer may be a MAC layer and the higher layer may be a PDCP layer or another layer, for example.

Optionally, at 806, if the first amount of the data is less than a threshold (e.g., the first threshold or a second threshold), the UE may send a BSR indicating the first amount of buffered data. The UE may then receive an uplink grant from the eNB according to the amount of buffered data indicated by the UE in the BSR.

### Example Cross-Layer Buffer Size Query for BSR Buffer Size Setting

According to certain aspects, the MAC entity (e.g., UE), may have an interface configured to query the upper layer regarding the actual amount of data buffered in the upper layer, which is denoted as S′. In aspects, S′ may indicate one or more portions of the actual amount of data buffered in the upper layer. The actual amount of data in the current layer's buffer, such as a Layer 2 buffer, of the UE (e.g., for the current TTI) is denoted as S. In this case, instead of setting the buffer size in the BSR to S bytes (e.g., to the entry in the table 700 corresponding to the amount of data S in the current layer's buffer), the UE may set the buffer size as S+S′ byte to indicate the total data buffered at the current layer's buffer and the higher layer buffer. Thus, the UE may receive enough uplink transmission grants to transmit the data buffered in the current layer's buffer and the data buffered in the higher layer buffer. In aspects, a higher or upper layer, such as an application layer, may indicate an active application and/or an application having a need for continuous data) in response to which the present methods and apparatus for BSR buffer size setting may be employed. In such aspects, S′ may be indicated by the higher layer, a preconfigured value and/or a value corresponding to a maximum upper layer buffer size.

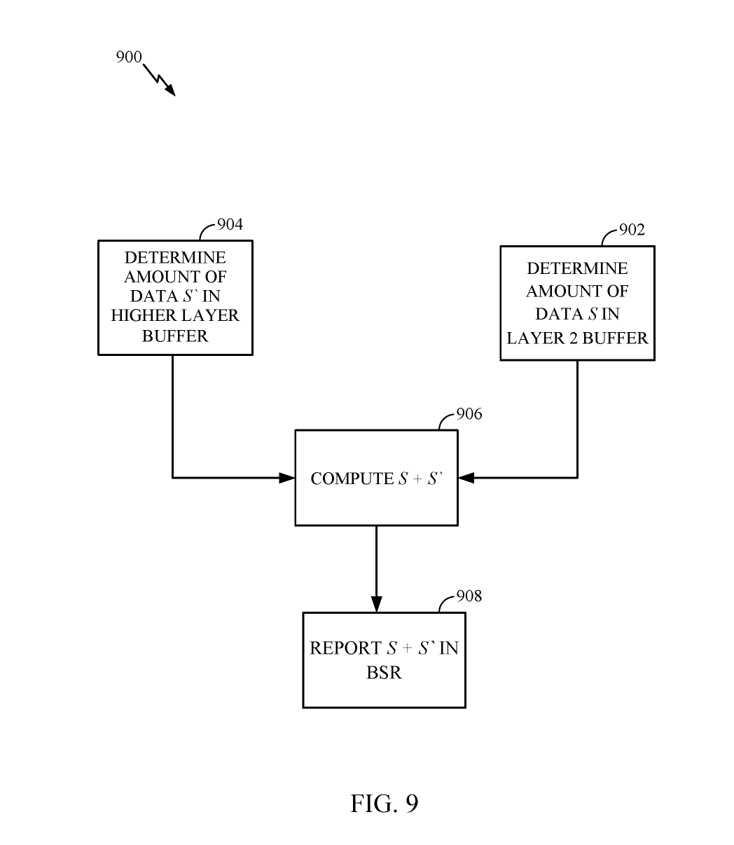

FIG. 9 is an example flow diagram 900 illustrating cross layer querying for a BSR, such as an eBSR, in accordance with aspects of the present disclosure. As shown in FIG. 9, at 902, the UE determines the amount of data S in the Layer 2 buffer. At 904, the UE determines the amount of data S′ in the higher layer buffer. At 906, the UE computes S+S′ and, at 908, the UE reports S+S′ in the BSR (e.g., sets the buffer size field to S+S′ byte).

### Example “One-Shot” Increase of Buffer Size Setting for BSR

According to certain aspects, the UE can set the buffer size to a “fake” value in the BSR, such as an eBSR, in order receive a larger and/or more uplink grant from the eNB.

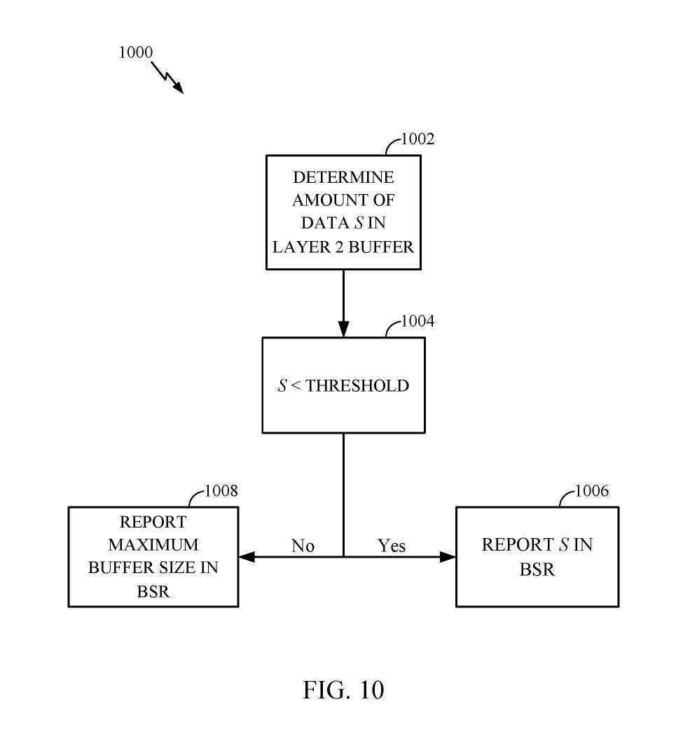

FIG. 10 is an example flow diagram 1000 illustrating a one-shot increase of buffer size setting for a BSR, such as an eBSR, in accordance with aspects of the present disclosure. For example, as shown in FIG. 10, at 1002, the UE may determine the amount of data S in the buffer (e.g., the Layer 2 buffer). At 1004, the UE may compare the amount of data S in the buffer to a buffer size threshold S_{threshold}. If the amount of the data S in the buffer is less than the threshold (e.g., S<S_{threshold}), then at 1006 the UE may set the buffer size to Sin the BSR. Alternatively, if the amount of the data S in the buffer satisfies (e.g., is equal to or greater than the threshold) (e.g., S≧S_{threshold}), then at 1008 the UE may set the buffer size to the maximum buffer size in the BSR (e.g., corresponding to index 63 in the table 700 corresponding to >3 MB).

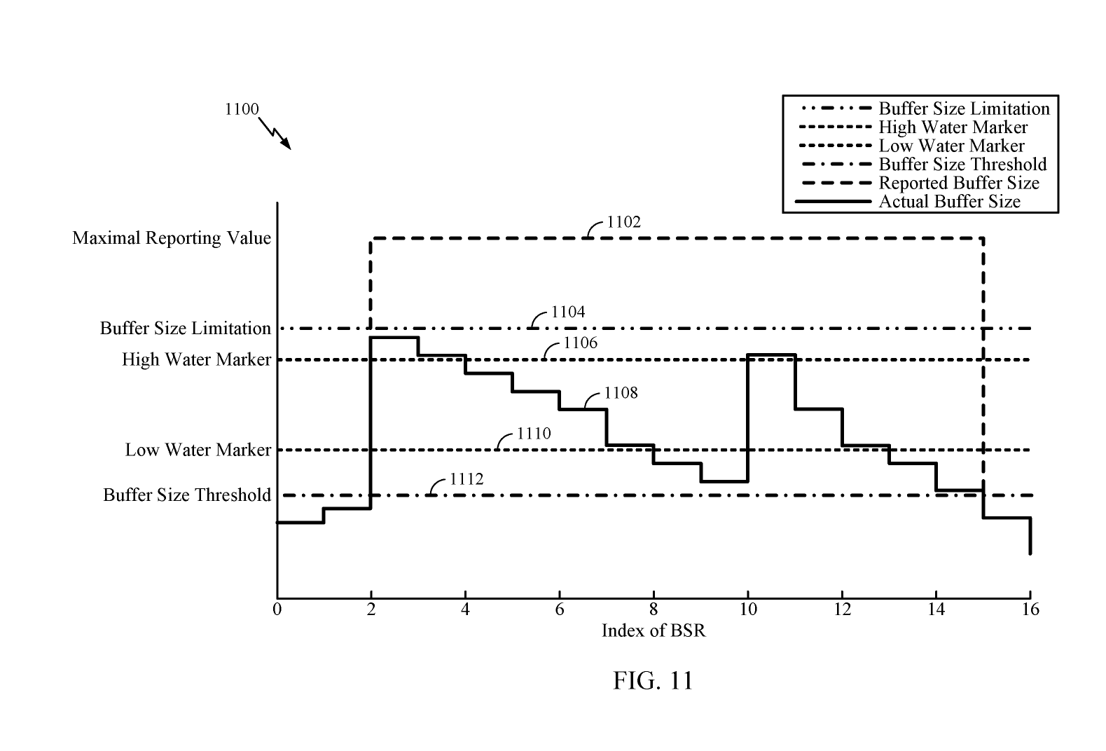

FIG. 11 is a graph 1100 illustrating the one-shot increase of buffer size setting for a BSR, such as an eBSR. In FIG. 11, line 1102 represents the reported buffer size; line 1104 represents the buffer size limitation; line 1106 represents a threshold such as the high watermark; line 1108 represents actual buffer size; line 1110 represents a threshold such as the low watermark; and line 1112 represents the buffer size threshold. As shown in FIG. 11, the actual buffer size (line 1108) cannot exceed the buffer size limitation (line 1104) which remains constant. As shown in FIG. 11, when the actual buffer size (line 1108) is below a threshold, such as the buffer size threshold (line 1112), the reported buffer size (line 1102) is the same as the actual buffer size (line 1108). However, when the actual buffer size (line 1108) is equal to or greater than the buffer size threshold (line 1112) the reported buffer size (line 1102) is at the maximum.

### Example Gradual Increase of Buffer Size Setting for a BSR Such as an eBSR

In another implementation for setting the buffer size to a “fake” value in the eBSR in order receive more uplink grant from the eNB, while the amount of data in the UE buffer is equal to or greater than the threshold, the UE may gradually increase the setting of the buffer size, rather than immediately setting the buffer size to the maximum.

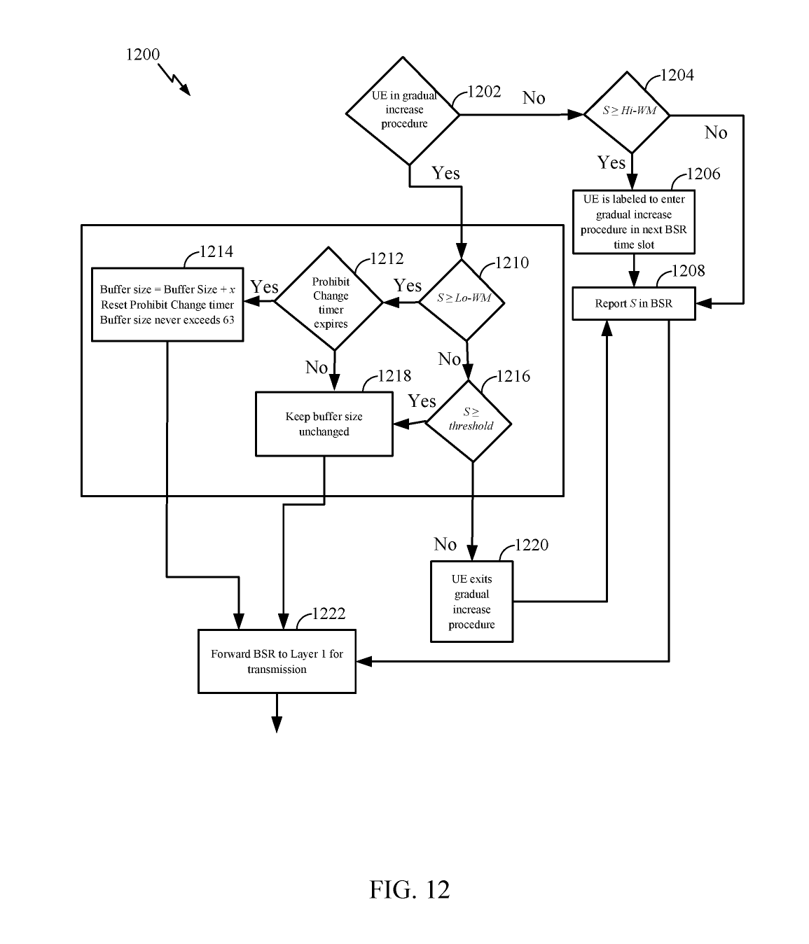

FIG. 12 is an example flow diagram 1200 illustrating a gradual increase of buffer size setting for a BSR, such as an eBSR, in accordance with certain aspects of the present disclosure. As shown in FIG. 12, at 1202, if the UE is not in a gradual increase procedure, the UE determines, at 1204, whether the amount of data in the buffer S is equal to or greater than the high watermark. If S is below the high watermark, the UE report Sin the BSR at 1208. If S is equal to or greater than the high watermark, then at 1206 the UE is labeled to enter the gradual increase procedure in the next buffer size report time slot and, at 1208, reports S in the BSR and forward the BSR to Layer 1 for transmission at 1222.

If the UE is already labeled in the gradual increase procedure, then at 1210 the UE determines is S is equal to or greater than the low watermark. If S is below the low watermark, then at 1216 the UE determines if S is equal to or greater than the threshold. If S is below the threshold, then at 1220 the UE exits the gradual increase procedure and reports S in the BSR at 1208. Otherwise, then at 1218, the UE keeps buffer size unchanged. If the UE determines that S is equal to or greater than the low watermark at 1210, then at 1212 the UE determines whether the prohibit change timer has expired. If the timer has not expired, then at 1218, the UE keeps the buffer size unhanged and sends the BSR to the Layer 1 for transmission at 1222. If the UE determines at 1212 that the prohibit change counter has expired, at 1214 the UE sets the buffer size to buffer size+x (e.g., 1 larger index or 1 entry larger in the table 700), as long as the buffer size never exceeds the maximum buffer size (e.g., corresponding to index 63 from the table 700) and resets the prohibit change counter. The UE then reports the buffer size+x in the BSR and forwards it to Layer 1 for transmission at 1222.

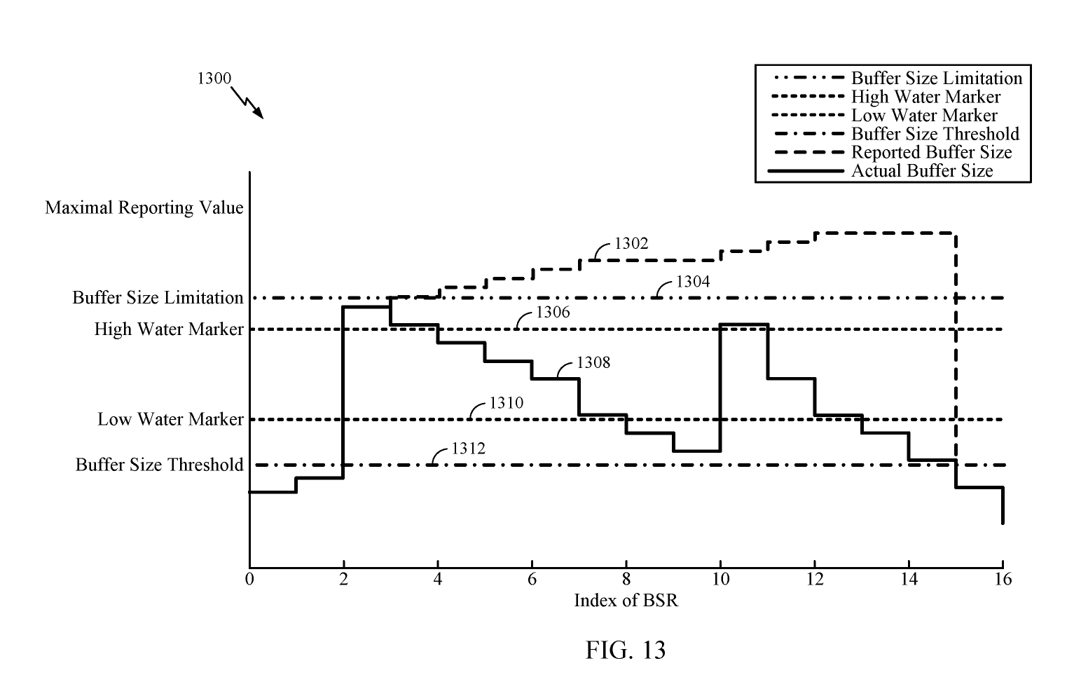

FIG. 13 is a graph 1300 illustrating gradual increase of buffer size setting for a BSR, such as an eBSR, in accordance with certain aspects of the present disclosure. In FIG. 13, line 1302 represents the reported buffer size; line 1304 represents the buffer size limitation; line 1306 represents the high watermark; line 1308 represents actual buffer size; line 1310 represents the low watermark; and line 1312 represents the buffer size threshold.

According to certain aspects, high and low watermarks may be used for setting the buffer size. High watermark (Hi-WM) corresponds to the level at which uplink flow control may be enabled and low watermark (Lo-WM) corresponds to the level at which uplink flow control may be disabled. For example, as shown in FIG. 13, if, initially, the actual buffer size (line 1308) is below the high watermark (line 1306), then the reported buffer size (line 1302) may be equal to the actual buffer size (line 1308) even though it is above the buffer size threshold (line 1312). Otherwise, e.g. if, initially, the actual buffer size (line 1308) is above the high watermark (line 1306), then the reported buffer size (line 1302) may be equal to the actual buffer size (line 1308) at first and enter the gradual increase procedure from now on. After that, for each time slot at which the UE calculates BSR, if the actual buffer size (line 1308) is above the low watermark (line 1310), the reported buffer size (line 1302) is increased (e.g., stepped) by 1, but never exceeds the maximum buffer size index (e.g., corresponding to index 63).

On the other hand, if the actual buffer size (line 1308) is above the buffer size threshold (line 1312) but below the low watermark (line 1310), then if the upper layer has early indication that it has no data to transmit, then the reported buffer size is the actual buffer size (e.g., reported according to the table 700) and the UE exits the gradual increase procedure; otherwise, the buffer size is unchanged. If the actual buffer size (line 1308) is below the buffer size threshold (line 1312), the reported buffer size is the actual buffer size (e.g., reported according to the table 700) and the UE exits the gradual increase procedure.

### Example Stepwise Increase/Decrease of Buffer Size Setting for BSR, Such as an eBSR

In another aspect for setting the buffer size to a “fake” value in the eBSR in order receive more uplink grant from the eNB the buffer size may be increased and decreased in a stepwise manner. For example, for each time slot in which the UE calculated BSR, if the actual amount of data in the UE buffer (e.g., the Layer 2 buffer) is above the high watermark, the UE sets the buffer size as S (e.g., according to table 700) and begins the gradual increase procedure.

During the gradual increase procedure, if S is above the low watermark and the buffer size stays at the maximum (e.g., corresponding to index 63) for y consecutive BSR periods, then the buffer size is reduced by x for y consecutive BSR periods; if S is above the low watermark and the buffer size drops by x for y consecutive BSR periods, then the buffer size is increased by x each BSR period until the buffer size is that corresponding to index 63.

During the gradual increase procedure, if S is equal to or above the buffer size threshold (e.g., S≧S_{threshold}), but below the low watermark, then: if the upper layer has early indication that it has no data to transmit, then the reported buffer size is the actual buffer size (e.g., reported according to the table 700) and the UE exits the gradual increase procedure; if the buffer size stays at the maximum (e.g., corresponding to index 63) for y consecutive BSR periods, then the buffer size is reduced by x for y consecutive BSR periods; if the buffer size drops by x for y consecutive BSR periods then the buffer size is increased by x each BSR period until the buffer size is 63; otherwise, the buffer size is unchanged.

During the gradual increase procedure, if S is below the buffer size threshold (e.g., S<S_{threshold}), the buffer size is set as S (e.g., reported according to the table 700) and the UE exits the gradual increase procedure.

The techniques described above for improving setting buffer size for a BSR such as an eBSR, may help the UE to receive more scheduled resources for uplink data transmissions which, in turn, may help the UE to transmit buffered data more efficiently (e.g., sooner).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

In some cases, rather than actually transmitting a frame, a device may have an interface to output a frame for transmission. For example, a processor may output a frame, via a bus interface, to an RF front end for transmission. Similarly, rather than actually receiving a frame, a device may have an interface to obtain a frame received from another device. For example, a processor may obtain (or receive) a frame, via a bus interface, from an RF front end for transmission.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

For example, means for determining, means for indicating, and/or means for including, may comprise a processing system, which may include one or more processors, such as the TX processor 616, transmitter(s) 618, and/or the controller/processor 675 of the wireless base station 610 illustrated in FIG. 6, and/or the TX processor 668, the transmitter(s) 654, and/or the controller/processor 659 of the user equipment 650 illustrated in FIG. 6. Means for transmitting and/or means for sending may comprise a transmitter, which may include TX processor 616, transmitter(s) 618, and/or the antenna(s) 620 of the wireless base station 610 illustrated in FIG. 6, and/or the TX processor 668, the transmitter(s) 654, and/or the antenna(s) 652 of the user equipment 650 illustrated in FIG. 6. Means for receiving may comprise a receiver, which may include RX processor 670, receiver(s) 618, and/or the antenna(s) 620 of the wireless base station 610 illustrated in FIG. 6, and/or the RX processor 656, the receiver(s) 654, and/or the antenna(s) 652 of the user equipment 650 illustrated in FIG. 6.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a wireless node (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, phase change memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein.

Further, it should be appreciated that modules and/or other appropriate means for performing the methods and techniques described herein can be downloaded and/or otherwise obtained by a wireless node and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a wireless node and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communication by a user equipment (UE), comprising:
determining a first amount of data stored in a buffer at the UE; and
if the first amount of the data satisfies a threshold, sending a first buffer status report (BSR) indicating a second amount of buffered data at the UE greater than the first amount.

2. The method of claim 1, wherein the indicated second amount of buffered data is greater than a maximum size of the buffer.

3. The method of claim 1, further comprising storing a table at the UE, wherein:
the table comprises a plurality of entries, one or more of the entries corresponding to a range of amount of buffered data; and
the indication of the second amount of buffered data is provided via one or more bits in the BSR having values that correspond to an entry in the table.

4. The method of claim 3, wherein the indicated second amount of buffered data corresponds to an entry in the table that corresponds to a maximum range of amount of buffered data.

5. The method of claim 1, further comprising:
determining a third amount of buffered data at the UE after sending the first BSR; and
if the third amount satisfies the threshold, sending a second BSR indicating a fourth amount of buffered data at the UE greater than the second amount.

6. The method of claim 4, further comprising:
periodically determining an amount of data in the buffer; and
if the amount of data in the buffer satisfies the threshold, reporting an amount of buffered data by the UE greater than the determined amount, wherein each subsequent reported amount is greater than the preceding reported amount.

7. The method of claim 1, wherein:
the first amount of buffered data is buffered at a lower layer;
the method further comprises receiving information from a higher layer regarding a third amount of buffered data at the higher layer; and
the second amount is based on the first amount and the third amount.

8. The method of claim 1, wherein the first BSR comprises an extended BSR.

9. The method of claim 1, further comprising receiving an uplink grant, a size of the uplink grant based on the indicated second amount of buffered data in the first BSR.

10. The method of claim 1, further comprising:
if the first amount of the data does not satisfy a threshold, sending a second buffer status report (BSR) indicating the first amount of buffered data.

11. An apparatus for wireless communication by a user equipment (UE), comprising:
means for determining a first amount of data stored in a buffer at the UE; and
means for sending a first buffer status report (BSR) indicating a second amount of buffered data at the UE greater than the first amount if the first amount of the data satisfies a threshold.

12. The apparatus of claim 11, wherein the indicated second amount of buffered data is greater than a maximum size of the buffer.

13. The apparatus of claim 11, further comprising means for storing a table at the UE, wherein:
the table comprises a plurality of entries, one or more of the entries corresponding to a range of amount of buffered data; and
the indication of the second amount of buffered data is provided via one or more bits in the BSR having values that correspond to an entry in the table.

14. The apparatus of claim 13, wherein the indicated second amount of buffered data corresponds to an entry in the table that corresponds to a maximum range of amount of buffered data.

15. The apparatus of claim 11, further comprising:
means for determining a third amount of buffered data at the UE after sending the first BSR; and
means for sending a second BSR indicating a fourth amount of buffered data at the UE greater than the second amount if the third amount satisfies the threshold.

16. The apparatus of claim 14, further comprising:
means for periodically determining an amount of data in the buffer; and
means for reporting an amount of buffered data by the UE greater than the determined amount if the amount of data in the buffer satisfies the threshold, wherein each subsequent reported amount is greater than the preceding reported amount.

17. The apparatus of claim 11, wherein:
the first amount of buffered data is buffered at a lower layer;
the apparatus further comprises means for receiving information from a higher layer regarding a third amount of buffered data at the higher layer; and
the second amount is based on the first amount and the third amount.

18. The apparatus of claim 11, wherein the first BSR comprises an extended BSR.

19. The apparatus of claim 11, further comprising means for receiving an uplink grant, a size of the uplink grant based on the indicated second amount of buffered data in the first BSR.

20. The apparatus of claim 11, further comprising means for sending a second buffer status report (BSR) indicating the first amount of buffered data if the first amount of the data does not satisfy a threshold.

21. An apparatus for wireless communication by a user equipment (UE), comprising:
at least one processor configured to determine a first amount of data stored in a buffer at the UE and, if the first amount of the data satisfies a threshold, send a first buffer status report (BSR) indicating a second amount of buffered data at the UE greater than the first amount; and
a memory coupled with the at least one processor.

22. The apparatus of claim 21, wherein the indicated second amount of buffered data is greater than a maximum size of the buffer.

23. The apparatus of claim 21, wherein:
the at least one processor is further configured to store a table at the UE:
the table comprises a plurality of entries, one or more of the entries correspond to a range of an amount of buffered data; and
the indication of the second amount of buffered data is provided via one or more bits in the BSR having values that correspond to an entry in the table.

24. The apparatus of claim 23, wherein the indicated second amount of buffered data corresponds to an entry in the table that corresponds to a maximum range of amount of buffered data.

25. The apparatus of claim 21, wherein the at least one processor is further configured to:
determine a third amount of buffered data at the UE after sending the first BSR; and
if the third amount satisfies the threshold, send a second BSR indicating a fourth amount of buffered data at the UE greater than the second amount.

26. The apparatus of claim 24, wherein the at least one processor is further configured to:
periodically determine an amount of data in the buffer; and
if the amount of data in the buffer satisfies the threshold, report an amount of buffered data by the UE greater than the determined amount, wherein each subsequent reported amount is greater than the preceding reported amount.

27. The apparatus of claim 21, wherein:
the first amount of buffered data is buffered at a lower layer;
the at least one processor is further configured to receive information from a higher layer regarding a third amount of buffered data at the higher layer; and
the second amount is based on the first amount and the third amount.

28. The apparatus of claim 21, wherein the at least one processor is further configured to receive an uplink grant, a size of the uplink grant based on the indicated second amount of buffered data in the first BSR.

29. The apparatus of claim 21, wherein the at least one processor is further configured to send a second buffer status report (BSR) indicating the first amount of buffered data if the first amount of the data does not satisfy a threshold.

30. A computer readable medium having computer executable code stored thereon, comprising:
code for determining a first amount of data stored in a buffer at a user equipment (UE); and
code for sending a first buffer status report (BSR) indicating a second amount of buffered data at the UE greater than the first amount if the first amount of the data satisfies a threshold.
